(19) United States
(12) Patent Application Publication
(10) Pub. No.: US 2006/0036023 A1
(43) Pub. Date: Feb. 16, 2006

(54) Color filter black matrix resist composition

(76) Inventors: Hirotoshi Kamata, Kanagawa (JP); Masanao Kamijo, Kanagawa (JP); Mina Onishi, Kanagawa (JP)

Correspondence Address: SUGHRUE MION, PLLC, 2100 PENNSYLVANIA AVENUE, N.W., SUITE 800, WASHINGTON, DC, 20037, US

(21) Appl. No.: 10/539,037

(22) PCT Filed: Dec. 15, 2003
(86) PCT No.: PCT/JP03/16017

§ 371 Date: Jun. 15, 2005

Related U.S. Application Data
(60) Provisional application No. 60/435,284, filed on Dec. 23, 2002.

(30) Foreign Application Priority Data
Dec. 16, 2002 (JP) 2002-364274

(51) Int. Cl. C08L 31/00

(52) U.S. Cl. 524/556

(57) ABSTRACT

The present invention relates to (1) a photosensitive composition for color filter black matrix resists, containing (A) a binder resin having a carboxyl group, (B) a compound having an ethylenically unsaturated bond, (C) a photopolymerizing initiator, (D) a thiol compound having two or more mercapto-group-containing groups in which carbon atoms at the a-position and/or n-position with respect to the mercapto group have a substituent, and (E) an organic solvent, and having high sensitivity and excellent storage stability; and (2) color filterblack blackmatrix resist containing (1) the photosensitive composition for color filter black matrix resists and a black pigment (F).

### CROSS-REFERENCE TO THE RELATED APPLICATIONS

This is an application filed pursuant to 35 U.S.C. Section 111 (a) with claiming-the benefit of U.S. Provisional application Ser. No. 60/435,284 filed Dec. 23, 2002, under the provision of 35 U.S.C. Section 111(b), pursuant to 35 U.S.C. Section 119(e)(1).

### TECHNICAL FIELD

The present invention relates to a photosensitive composition for a color filter black matrix resist that contains a branched multifunctional thiol compound and concomitantly exhibits high sensitivity and storage stability and to a color filter black matrix resist composition that uses the same.

### BACKGROUND ART

Photosensitive compositions are used in printing plates, color proofs, color filters, solder resists, and photocuring inks and in various other fields. Particularly, in recent years, room-temperature, rapid drying, solvent-free and the like properties, which are major characteristics of photocuring, have been attracting attention from the viewpoints of environmental protection, energy saving, working safety, production cost and so forth, and numerous studies and developments are under way.

Among these, in development of color filters for use in color television sets, liquid crystal display devices, solid image pickup devices, cameras and so forth, studies on pigment dispersed type resist for color filters are being made for the purpose of increasing productivity and for achieving high resolution. A color filter have formed therein three or more different hue patterns, such as red (R), green (G) and blue (B) with a precision of several micrometers (μm). Usually, there are arranged between such hue patterns grid-like shielding black matrices in order to increase the contrast. In such application of the color filter, there has been an increasing demand for a photosensitive composition and those photosensitive compositions that cure more rapidly with low energy, ensure formation of patterns with high resolution and have larger curing depth and higher storage stability are sought.

A photosensitive composition is composed mainly of a photopolymerization initiator, a compound having an ethylenically unsaturated bond that cures by a polymerization reaction, and various additives, and the components are selected depending on the application of the photosensitive composition.

The photopolymerization initiator is selected by its photosensitive wavelength and polymerization initiating property. The compound having an ethylenically unsaturated bond and additives are selected by their polymerizability and the physical properties of the cured product. These are used in combination. However, some types of the compound having an ethylenically unsaturated bond or of the additive, cause (1) a problem that sufficient energy for starting photopolymerization is not obtained, (2) a problem that storage stability is not obtained, (3) a problem that the irradiated light cannot reach deep enough due to the thickness of the target cured product, resulting in insufficient curing, (4) a problem that inhibition by oxygen occurs at a portion where the photosensitive composition contacts the atmosphere, and so forth.

Various attempts have been made to avoid these problems; for example, irradiation of higher energy, addition of an excess amount of photopolymerization initiator, adoption of an oxygen shielding membrane, and so forth. However, also for saving energy and reducing production cost, a photosensitive composition having more excellent photocuring properties and storage stability is desired.

In particular, black matrix resist used in producing color filters are desired to be highly sensitive and excellent in developability and also excellent in storage stability. That is, color filters are usually produced by forming a black matrix on a surface of a transparent substrate such as glass or plastic sheet and then patterns of three or more different hues, such as red (R), green (G), blue (B) and so forth in a precision of several micrometers.

Heretofore, there have been used photosensitive compositions produced by a pigment dispersion method where a light-shielding pigment is dispersed for black matrices. In recent years, color filters that have more excellent color contrast using pigments in higher concentration are being desired. However, use of pigments in higher concentrations lead to a decrease in sensitivity and developability, so that it has been proposed to use a multifunctional thiol compound in order to improve the developability of the photosensitive composition. However, those photosensitive compositions so far proposed in which multifunctional thiol compounds are used have a disadvantage that their storage stability is poor. For example, regarding the use of a multifunctional thiol compound in a photopolymerizable composition for color filters that is suitable for forming black matrices, for example, JP-A-10-253815 (the term “JP-A” as used herein means an “unexamined published Japanese patent application”), JP-A-10-253816 and JP-A-10-253817 disclose photopolymerizing compositions that contain a multifunctional thiol compound and an initiator selected from a group consisting of a biimidazole compound, a titanocene compound, a triazine compound and an oxazole compound, and JP-A-2000-249822 discloses a photopolymerization initiator including a sensitizer, an organic boron complex and a compound having a mercapto group. However, in these techniques, there is a problem that attempts to achieve high sensitivity with such multifunctional thiols deteriorate storage stability.

Therefore, development of a black matrix resist for color filters, having high sensitivity and excellent developability as well as excellent storage stability and of a photosensitive composition for use therein is desired.

An object of the present invention is to provide a photosensitive composition for color filter black matrix resists that has high sensitivity and excellent storage stability and a color filter black matrix resist composition using the photosensitive composition.

### DISCLOSURE OF THE INVENTION

The inventors of the present invention have found that the above-mentioned problems can be solved by using in a photosensitive composition, a multifunctional thiol compound that has a structure where a carbon atom at α-position and/or β-position with respect to a mercapto group has a substituent, specifically a multifunctional thiol compound having a structure which is branched on the carbon atom at α-position and/or β-position with respect to a mercapto group, more specifically, a branched multifunctional thiol compound including two or more of branched structure in each of which a carbon atom at α-position and/or β-position with respect to a mercapto group forms three or more bonds with atoms other than hydrogen atoms, thus achieving the present invention.

That is, the present invention relates to photosensitive compositions for color filter matrix resists as described in 1 to 13 below and to color filter black matrix resist compositions as described in 14 to 16 below. 1. A photosensitive composition for color filter black matrix resists, comprising (A) a binder resin having a carboxyl group, (B) a compound having an ethylenically unsaturated bond, (C) a photopolymerizing initiator, (D) a thiol compound having two or more mercapto-group-containing groups in which carbon atom(s) at α-position and/or β-position with respect to the mercapto group have a substituent, and (E) an organic solvent. 2. The photosensitive composition for color filter black matrix resists according to 1 above, wherein at least one of the substituents in the thiol compound (D) is an alkyl group. 3. The photosensitive composition for color filter black matrix resists according to 2 above, wherein the alkyl group of the thiol compound (D) is a linear or branched alkyl group having 1 to 10 carbon atoms. 4. The photosensitive composition for color filter black matrix resists according to 1 above, wherein the mercapto-group-containing group of the thiol compound (D) is represented by the following formula (1)
—(CH₂)ₘC(R¹)(R²)(CH₂)ₙSH (1)
(in the formula, R¹ and R² independently represent each a hydrogen atom or an alkyl group, at least one of R¹ and R² is an alkyl group, m is an integer of 0 or 1 to 2, and n is 0 or 1.) 5. The photosensitive composition for color filter black matrix resists according to any one of 1 to 4 above, wherein the thiol compound (D) is an ester of a mercapto group-containing carboxylic acid represented the following formula (2)
HO—CO—(CH₂)ₘC(R¹)(R²)(CH₂)ₙSH (2)
(in the formula, R¹ and R² independently represent each a hydrogen atom or an alkyl group, at least one of R¹ and R² is alkyl group, m is an integer of 0 or 1 to 2, and n is 0 or 1) with a multifunctional alcohol. 6. The photosensitive composition for color filter black matrix resists according to 5 above, wherein the multifunctional alcohol is one or more of compounds selected from a group consisting of alkylene glycol (provided that the alkylene group has 2 to 10 carbon atoms and may be branched), diethylene glycol, glycerol, dipropylene glycol, trimethylolpropane, pentaerythritol and dipentaerythritol. 7. The photosensitive composition for color filter black matrix resists according to 5 above, wherein the multifunctional alcohol is a high molecular polymer having a hydroxyl group. 8. The photosensitive composition for color filter black matrix resists according to 1 above, wherein the binder resin having a carboxyl group (A) further has an ethylenically unsaturated group. 9. The photosensitive composition for color filter black matrix resists according to 8 above, wherein the binder resin having a carboxyl group (A) is an acrylic copolymer. 10. The photosensitive composition for color filter black matrix resists according to 1 above, wherein the photopolymerization initiator (C) contains a hexaaryl biimidazole compound and/or an aminonacetophenone compound. 11. The photosensitive composition for color filter black matrix resists according to 10 above, wherein the hexaaryl biimidazole compound is represented by the following formula (3)

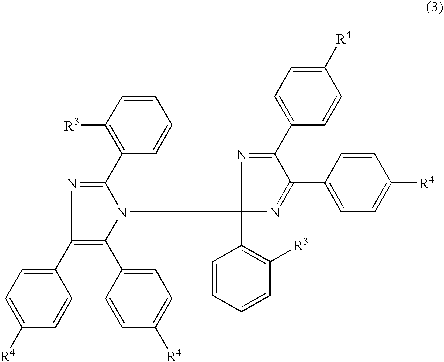

(in the formula, R³represents a halogen atom, R⁴ represents an alkyl group having 1 to 4 carbon atoms that may have a substituent, or an alkoxy group that may have a substituent). 12. The photosensitive composition for color filter black matrix resists according to 1 above, wherein the photopolymerization initiator (C) contains at least one compound selected from the group consisting of a benzophenone-based compound, a thioxanthone-based compound, and a ketocoumarin-based compound as a sensitizer. 13. The photosensitive composition for color filter black matrix resists according to 1 above, wherein respective components excluding the organic solvent (E) are contained in the following ratio based on the total amount of the components:

| | | |
|---|---|---|
| (A) | a binder resin having a carboxyl group | 30 to 70 mass % |
| (B) | a compound having an ethylenically | 5 to 40 mass % |
| | unsaturated compound | |
| (C) | a photopolymerization initiator | 3 to 30 mass % |
| (D) | a thiol compound having two or more | 3 to 30 mass % |
| | mercapto-group-containing groups in which | |
| | carbon atoms at the α-position and/or | |
| | β-position with respect to the mercapto | |
| | group have a substituent | |

14. A color filter black matrix resist composition comprising the photosensitive composition for color filter black matrix resists according to any one of 1 to 13 above and a black pigment (F). 15. The color filter black matrix resist composition comprising the photosensitive composition according to 14 above, wherein the black pigment (F) contains carbon black. 16. The color filter black matrix resist composition comprising the photosensitive composition according to 14 above, wherein respective components excluding the organic solvent (E) are contained in the following ratios based on the total amount of the components:

| | | |
|---|---|---|
| (A) | a binder resin having a carboxyl group | 10 to 30 mass % |
| (B) | a compound having an ethylenically | 2 to 20 mass % |
| | unsaturated compound | |
| (C) | a photopolymerization initiator | 2 to 15 mass % |
| (D) | a thiol compound having two or more | 2 to 15 mass % |
| | mercapto-group-containing groups in which | |
| | carbon atoms at the α-position and/or | |
| | β-position with respect to the mercapto | |
| | group have a substituent | |
| (F) | a black pigment | 40 to 70 mass %. |

### DETAILED DESCRIPTION OF THE INVENTION

Hereinafter, embodiments of the present invention will be described.

The photosensitive composition for color filter black matrix resists (hereinafter, referred to simply as “photosensitive composition” in some cases) comprises (A) a binder resin having a carboxyl group, (B) a compound having an ethylenically unsaturated bond, (C) a photopolymerization initiator, (D) a thiol compound having two or more mercapto-group-containing groups in which carbon atoms at the α-position and/or β-position with respect to the mercapto group have a substituent, and (E) an organic solvent.

Further, the color filter black matrix resist composition (hereinafter, referred to simply as “resist composition” in some cases) comprises the above-mentioned photosensitive composition and the black pigment (F) blended therewith.

(1) (A) Binder Resin Having a Carboxyl Group

The binder resin (A) used in the present invention has a carboxyl group in its side chain and is a component that determines various properties of the resist, such as film strength, heat resistance, substrate adhesion, solubility in aqueous alkali solutions (alkali developability) and so forth.

Specific examples thereof include an acrylic copolymer (AP) having a carboxyl group and an epoxy (meth)acrylate resin (EA) having a carboxyl group. The acrylic copolymer and epoxy acrylate resin may be used in combination of two or more of them.

Among these, particularly preferred are those having a carboxyl group in the side chain and also an ethylenically unsaturated in the side chain, and specifically, mention may be made of the above-mentioned acrylic copolymer (AP).

(i) Acrylic Copolymer (AP) Having a Carboxyl Group The acrylic copolymer (AP) having a carboxyl group is obtained by copolymerizing (a) a carboxyl-group-containing ethylenically unsaturated monomer and (b) an ethylenically unsaturated monomer other than (a).

The carboxyl-group-containing ethylenically unsaturated monomer (a) is used for imparting the acrylic copolymer with alkali developability. Specific examples of the carboxyl-group-containing ethylenically unsaturated monomer include (meth)acrylic acid, 2-(meth)acryloyloxyethyl succinic acid, 2-(meth)acryloyloxyethylphthalic acid, (meth)acryloyloxyethylhexahydrophthalic acid, (meth)acrylic acid dimer, maleic acid, crotonic acid, itaconic acid, and fumaric acid.

Note that “(meth)acrylic acid” as used herein means both acrylic acid and methacrylic acid while the term “(meth)acryloyl” used herein means both acryloyl and methacryloyl.

The ethylenically unsaturated monomer (b) other than (a) above is used for controlling the strength and pigment dispersability of the film. Specific examples thereof include vinyl compounds such as styrene, α-methylstyrene, (o,m,p-)hydroxystyrenes and vinyl acetate, (meth)acrylates such as methyl (meth)acrylate, ethyl (meth)acrylate, n-propyl (meth)acrylate, isopropyl (meth)acrylate, n-butyl (meth)acrylate, tert-butyl (meth)acrylate, n-hexyl (meth)acrylate, cyclohexyl (meth)acrylate, benzyl (meth)acrylate, phenoxyethyl (meth)acrylate, isobornyl (meth)acrylate, tetrahydrofurfuryl (meth)acrylate, (meth)acrylonitrile, glycidyl (meth)acrylate, allyl glycidyl ether, 2-hydroxyethyl (meth)acrylate, 2-hydroxypropyl (meth)acrylate, N,N-dimethylaminoethyl (meth)acrylate, trifluoroethyl acrylate, 2,2,3,3-tetrafluoropropyl (meth)acrylate and perfluorooctylethyl (meth)acrylate, and compounds having an amide group, such as (meth)acrylamide, N,N-dimethyl (meth)acrylamide, N,N-diethyl (meth)acrylamide, N-methyl (meth)acrylamide, N-ethyl (meth)acrylamide, N-isopropyl (meth) acrylamide, N-vinylpyrrolidone, N-vinylcaprolactam, and N-(meth)acryloylmorpholine.

Further, there may be used those acrylic copolymers having an ethylenically unsaturated bond in the side chain that are obtained by reacting a carboxyl groups in a portion of the side chain of the acrylic copolymer obtained by copolymerizing the above-mentioned monomers with an epoxy group of a compound having an epoxy group and an ethylenically unsaturated group in one molecule, such as glycidyl (meth)acrylate, 3, 4-epoxycyclohexylmethyl (meth)acrylate, 4-(2,3-epoxypropoxy)butyl (meth)acrylate and allyl glycidyl ether, or by reacting a part or whole of hydroxyl groups of the acrylic copolymer with an isocyanate group of a compound having an isocyanate group and an ethylenically unsaturated group in one molecule, such as 2-methacryloyloxyethyl isocyanate.

Copolymerization ratio of (a) the carboxyl-group-containing ethylenically unsaturated monomer to (b) the ethylenically unsaturated monomer other than the (a) is preferably 5:95 to 40:60, more preferably 10:90to50:50, in mass ratio. If the copolymerization ratio of (a) is less than 5, the alkali developabililty is decreased so that it becomes difficult to form patterns. On the other hand, if the copolymerization ratio of (a) exceeds 60, alkali development of the photocured portion too readily proceeds so that it becomes difficult to maintain the line width of the patterns at a constant value.

A preferred molecular weight of the acrylic copolymer (AP) having a carboxyl group is within the range of 1,000 to 500,000, preferably 3,000 to 200,000 in a weight average molecular weight in terms of polystyrene obtained by GPC. If the molecular weight is less than 1,000, the film strength after curing decreases considerably. On the other hand, if the molecular weight exceeds 500,000, the alkali developability decreases considerably.

(ii) Epoxy (Meth)Acrylate Compound (EA) Having a Carboxyl Group

The epoxy (meth)acrylate compound having a carboxyl group used in the present invention is not particularly limited, however, epoxy (meth)acrylate compound obtained by reacting a reaction product between an epoxy compound and an unsaturated group-containing monocarboxylic acid with acid anhydride is suitable.

The epoxy compound used in the present invention is not particularly limited and examples thereof include epoxy compounds such as a bisphenol A type epoxy compound, a bisphenol F type epoxy compound, a bisphenol S type epoxy compound, a phenol novolak type epoxy compound, a cresol novolak type epoxy compound, or an aliphatic epoxy compound. These may be used singly or in combination of two or more of them.

Examples of the unsaturated group-containing monocarboxylic acid include (meth)acrylic acid, 2-(meth)acryloyloxyethylsuccinic acid, 2-(meth)acryloyloxyethylphthalic acid, (meth)acryloyloxyethylhexahydrophthalic acid, (meth)acrylic acid dimer, β-furfurylacrylic acid, β-styrylacrylic acid, cinnamic acid, crotonic acid and α-cyanocinnamic acid. Further examples thereof include half ester compounds that are reaction products between a hydroxyl group-containing acrylate and a saturated or unsaturated dibasic acid anhydride, and half ester compounds that are reaction products between an unsaturated group-containing monoglycidyl ether and a saturated or unsaturated dibasic acid anhydride. These unsaturated group-containing monocarboxylic acids may be used singly or in combination of two or more of them.

Examples of the acid anhydride include dibasic acid anhydrides such as maleic acid anhydride, succinic acid anhydride, itaconic acid anhydride, phthalic acid anhydride, tetrahydrophthalic acid anhydride, hexahydrophthalic acid anhydride, methylhexahydrophthatlic acid anhydride, endomethylenetetrahydrophthalic acid anhydride, and methylendomethylenetetrahydrophthalic acid anhydride, chlorendic acid anhydride and methyltetrahydrophtalic acid anhydride, aromatic polybasic carboxylic acid anhydrides such as trimellitic acid anhydride, pyromellitic acid anhydride and benzophenonetetracarboxylic acid dianhydride, and polybasic carboxylic acid anhydride derivatives such as 5-(2,5-dioxotetrahydrofuryl)-3-methyl-3-cyclohexene-1,2-dicarboxylic acid anhydride, endobicyclo-[2,2,1]-hept-5-ene-2,3-dicarboxylic acid anhydride. These may be used singly or in combination of two or more.

The molecular weight of the epoxy (meth)acrylate, compound (EA) having a carboxyl group thus obtained is not particularly limited, however, the weight average molecular weight in terms of polystyrene obtained by GPC is 1,000 to 40,000, more preferably 2,000 to 5,000.

Further, acid value (which means acid value of solid contents measured according to JIS K0070, hereinafter the same will apply) of the above-mentioned epoxy (meth) acrylate compound is 10 mgKOH/g or more, more preferably in the range of 45 mgKOH/g to 160 mgKOH/g, and particularly preferably in the range of 50 mgKOH/g to 140 mgKOH/g in view of well balanced alkali solubility and alkali resistance of the cured film. If the acid value is smaller than 10 mgKOH/g, the alkali solubility is deteriorated. On the contrary, if it is too large, this may be a factor that deteriorates the characteristics such as alkali resistance of the cured film, depending on the combinations of the constituent components of the photosensitive composition.

(2) (B) Compound Having an Ethylenically Unsaturated Group

The compound having an ethylenically unsaturated group (B) contained in the photosensitive composition of the present invention is other than the binder resin (A) described above and is used for adjusting the photosensitivity of the photosensitive composition or adjusting the physical properties-of cured product, such as heat resistance, flexibility and so forth. Preferably, (meth)acrylic acid esters are used.

Specific examples thereof include alkyl (meth)acrylates such as methyl (meth)acrylate, ethyl (meth)acrylate, propyl (meth)acrylate, n-butyl (meth)acrylate, isobutyl (meth)acrylate, sec-butyl (meth)acrylate, tert-butyl (meth)acrylate, hexyl (meth)acrylate, octyl (meth)acrylate, isooctyl (meth)acrylate, 2-ethylheyxyl (meth)acrylate, decyl (meth)acrylate; lauryl (meth)acrylate and stearyl (meth)acrylate; alicyclic (meth) acrylates such as cyclohexyl (meth) acrylate, bornyl (meth)acrylate, isobornyl (meth)acrylate, dicyclopentenyl (meth)acrylate, and dicyclopentenyloxyethyl (meth)acrylate; aromatic (meth)acrylates such as benzyl (meth)acrylate, phenyl (meth)acrylate, phenylcarbitol (meth)acrylate, nonylphenyl (meth)acrylate, nonylphenylcarbitol (meth)acrylate and nonylphenoxy (meth)acrylate; (meth)acrylates having a hydroxyl group, such as 2-hydroxyethyl (meth)acrylate, hydroxypropyl (meth)acrylate, hydroxybutyl (meth)acrylate, butanediol mono (meth) acrylate, glycerol (meth) acrylate, polyethylene glycol (meth)acrylate and glycerol di(meth)acrylate; (meth)acrylates having an amino group such as 2-dimethylaminoethyl (meth)acrylate, 2-diethylaminoethyl (meth)acrylate and 2-tert-butylaminoethyl (meth)acrylate; (meth)acrylates having a phosphorus atom, such as methacryloxyethyl phosphate, bis(methacryloxy)ethyl phosphate and methacryolxyethyl phenyl acid phosphate; di(meth)acrylates such as ethylene glycol di(meth)acrylate, diethylene glycol di(meth)acrylate, triethylene glycol di(meth)acrylate, tetraethylene glycol di(meth)acrylate, polyethylene glycol di(meth)acrylate, propylene glycol di(meth)acrylate, dipropylene glycol di(meth)acrylate, tripropylene glycol di(meth)acrylate, 1,4-butanediol di(meth)acrylate, 1,3-butanediol di(meth)acrylate, neopentyl glycol di(meth)acrylate, 1,6-hexanediol di(meth)acrylate and bis(glycidyl (meth)acrylate); poly(meth)acrylates such as trimethylolpropane tri(meth)acrylate, pentaerythritol tri(meth)acrylate, and dipentaerythritol hexa(meth)acrylate; modified polyol poly (meth) acrylates such as 4 mol ethylene oxide-added bisphenol S di(meth)acrylate, 4 mol ethylene oxide-added bisphenol A di(meth)acrylate, fatty acid-modified pentaerythritol di(meth)acrylate, 3 mol propylene oxide-added trimethylolpropane tri(meth)acrylate, and 6 mol propylene oxide-added trimethylolpropane tri(meth)acrylate; polyacrylates having an isocyanuric acid skeleton, such as bis(acryloyloxyethyl) monohydroxyethyl isocyanurate, tris(acryloyloxyethyl) isocyanurate, and ε-caprolactone-added tris (acryloyloxyethyl) isocyanurate; polyester acrylates such as α,ω-diacryloyl-(bisethyleneglycol)phthalate and α,ω-tetraacryloyl-(bistrimethylolpropane)-tetrahydrophthalate; glycidyl (meth)acrylate; allyl (meth)acrylate; ω-hydroxyhexanoyloxyethyl(meth)acrylate; polycaprolactone (meth)acrylate; (meth)acryloyloxyethyl phthalate; (meth)acryloyloxyethylsuccinate; 2-hydroxy-3-phenoxypropyl acrylate; phenoxyethyl acrylate, and the like.

In addition, N-vinyl compounds such as N-vinylpyrrolidone, N-vinylformamide and N-vinylacetamide, polyester (meth)acrylate, urethane (meth)acrylate, epoxy (meth)acrylate and the like may be preferably used as the compound having an ethylenically unsaturated group.

Preferred among these are poly (meth)acrylates such as trimethylolpropane tri(meth)acrylate, pentaerythritol tetra(meth)acrylate and dipentaerythritol hexa(meth)acrylate, which enhance high photosensitivity.

The blending ratio ((A): (B)) of (A) the binder resin to (B) the compound having an ethylenically unsaturated group is within a range of 95:5 to 50:50, preferably 90:10 to 60:40, more preferably 85:15 to 70:30 in mass ratio. If the blending amount of (A) the binder resin exceeds 95mass %, unpreferably the photosensitivity decreases while if the blending amount of (A) the binder resin is less than 50 mass %, the line width of patterns unpreferably becomes broad.

(3) (C)Photopolymerization Initiator

Components used for ordinary photopolymerization initiators (for example, radical generators, sensitizers, etc.) may be used in the photopolymerization initiator (C) In the present invention, the photopolymerization initiator (C) means a composition containing a series of compounds that initiates photopolymerization, including ordinary photopolymerization initiators, sensitizers, etc. Therefore, it may be a single chemical substance or a combination of a plurality of chemical substances.

Such components include, for example, biimidazole compounds and/or acetophenone compounds that act as radical generators. Further, at least one compound selected from the group consisting of benzophenone-based compounds, thioxanthone-based compounds and ketocoumarin-based compounds that act primarily as sensitizers is included. These components may be used singly or two or more of them may be used in combination.

(i) Biimidazole-based Compound and/or Acetophenone-based Compound

As the biimidazole-based compound used in the present invention, any one of those generally used in ordinary photopolymerization initiators can be used. Preferable examples thereof include hexaaryl biimidazole compounds, more preferably hexaaryl biimidazole compounds having a structure represented by the following formula (4).

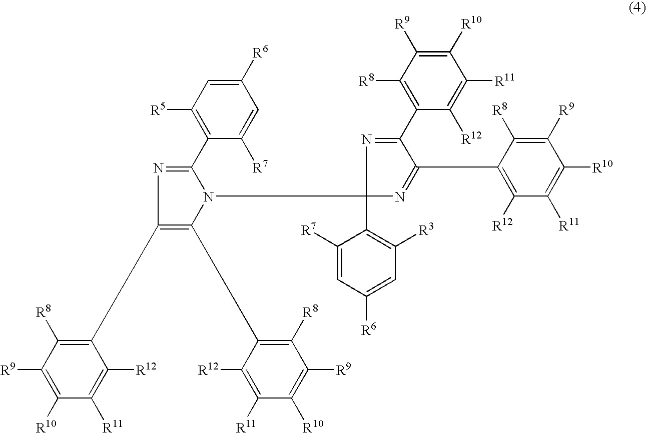

In the formula (4) above, R⁵, R⁶, and R⁷ independently represent each a halogen atom, a cyano group, or a nitro group, R⁸, R⁹, R¹⁰, R¹¹, and R¹² independently represent each a hydrogen atom, an alkyl group optionally having a substituent, or an alkoxy group optionally having a substituent. The halogen atom includes a chlorine atom, a bromine atom, a fluorine atom or the like.

Examples of the alkyl group include linear or branched ones having preferably 1 to 6 carbon atoms, more preferably 1 to 3 carbon atoms. Specific examples thereof include a methyl group, an ethyl group, an n-propyl group, an i-propyl group, an n-butyl group, an i-butyl group, a t-butyl group, an n-pentyl group and an n-hexyl group. These groups may have a substituent such as an alkoxy group or a halogen atom.

Examples of the alkoxy group includes linear or branched ones having preferably 1 to 6 carbon atoms, more preferably 1 to 3 carbon atoms. Specific examples thereof include a methoxy group, an ethoxy group, a propoxy group, an n-butoxy group, an i-butoxy group, a t-butoxy group, an n-pentyloxy group, and an n-hexyloxy group. These groups may have a substituent such as an alkoxy group or a halogen atom.

As such a hexaaryl biimidazole compound, a compound having a structure represented by the following formula (3) is exemplified as particularly preferred.

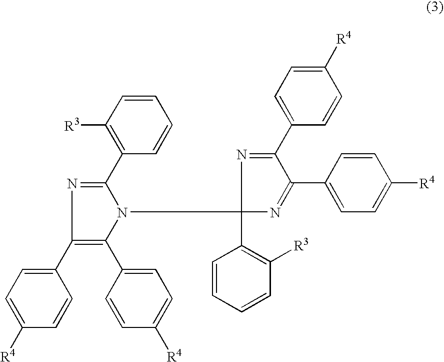

In the formula (3), R³ represents a halogen atom, R⁴ represents an alkyl group having 1 to 4 carbon atoms optionally having a substituent or an alkoxy group optionally having a substituent. Examples of the alkyl group or alkoxy group represented by R⁴ include similar ones that are exemplified with respect to R8 to R¹² in formula (4) (provided that the number of carbons is 1 to 4), and particularly preferred are a methyl group and a methoxy group. The halogen atom is particularly preferably a chlorine atom.

As the acetophenone-based compound used in the present invention, hydroxyacetophenone-based compounds and aminoacetophenone-based compounds may be exemplified. Among these, aminoacetophenone-based compounds are used particularly preferably from the viewpoint of photosensitivity.

Examples of the hydroxyacetophenone compound include α-hydroxyacetophenones such as 2-hydroxy-2-methyl-l-phenylpropan-1-one, 2-hydroxy-2-methyl-1-phenylbutan-1-one, 1-(4-methylphenyl)-2-hydroxy-2-methylpropan-1-one, 1-(4-isopropylphenyl)-2-methylpropan-1-one, 1-(4-butylphenyl)-2-hydroxy-2-methylpropan-1-one, 2-hydroxy-2-methyl-1-(4-octylphenyl)propan-1-one, 1-(4-dodecylphenyl)-2-methylpropan-1-one, 1-(4-methoxyphenyl)-2-methylpropan-1-one, 1-(4-methylthiophenyl)-2-methylpropan-1-one, 1-(4-chlorophenyl)-2-hydroxy-2-methylpropan-1-one, 1-(4-bromophenyl)-2-hydroxy-2-methylpropan-1-one, 2-hydroxy-1-(4-hydroxyphenyl)-2-methylpropan-1-one, 1-(4-dimethylaminophenyl)-2-hydroxy-2-methylpropan-1-one, 1-(4-carboethoxyphenyl)-2-hydroxy-2-methylpropan-1-one, 1-hydroxycyclohexylphenylketone, and 2-hydroxy-1-(4-(2-hydroxyethoxy)-phenyl)-2-methylpropan-1-one,

Examples of the aminoacetophenone compound include α-aminoacetophenones, such as 2-dimethylamino-2 -methyl-1-phenylpropan-1-one, 2-diethylamino-2-methyl-1-phenylpropan-1-one, 2-methyl-2-morpholino-1-phenylpropan-1-one, 2-dimethylamino-2-methyl-1-(4-methylphenyl)propan-1-one, 2-dimethylamino-1-(4-ethylphenyl)-2-methylpropan-1-one, 2-dimethylamino-1-(4-isopropylphenyl)-2-methylpropan-1-one, 1-(4-butylphenyl)-2-dimethylamino-2-methylpropan-1-one, 2-dimethylamino-1-(4-methoxyphenyl)-2-methylpropan-1-one, 2-dimethylamino-2-methyl-1-[(4-methylthio)phenyl]propan-1-one, 2-methyl-1-[(4-methylthio)phenyl]-2-morpholino-propan-1-one, 2-benzyl-2-dimethylamino-1-(4-morpholinophenyl)-butan-1-one, and 2-benzyl-2-dimethylamino-1-(4-dimethylaminophenyl)-butan-1-one.

(ii) Sensitizer

In the present invention, typical sensitizers employed in ordinary photopolymerization initiators may be used. To enhance the sensitivity, it is preferable that at least one compound selected from the group consisting of benzophenone-based compounds, thioxanthone-based compounds and ketocoumarin-based compounds is used.

Specifically, use may be made of benzophenone-based compounds such as benzophenone, 2,4,6-trimethylbenzophenone, 4-phenylbenzophenone, 4-benzoyl-4′-methyldiphenyl sulfide, 4,4′-bis(dimethylamino)benzophenone, and 4,4′-bis(diethylamino)benzophenone, thioxanthone-based compounds such as thioxanthone, 2-methylthioxanthone, 2,4-dimethylthioxanthone, 2,4-diethylthioxanthone, isopropylthioxanthone, 2,4-diisopropylthioxanthone and 2-chlorothioxanthone, ketocoumarin-based compounds such as 3-acethylcoumarin, 3-acetyl-7-diethylaminocoumarin, 3-benzoylcoumarin, 3-benzoyl-7-diethylaminocoumarin, 3-benzoyl-7-methoxycoumarin, 3,3′-carbonylbiscoumarin, 3,3′-carbonylbis(7-methoxycoumarin), and 3,3′-carbonylbis(5,7-dimethoxycoumarin). These may be used singly or mixture of two or more of them may be used.

The blending ratio of the above-mentioned sensitizer in the photopolymerization initiator is not particularly limited, however, preferably it is 5 to 40 mass %, more preferably 10 to 30 mass % of the total amount of the photopolymerization initiator. If the blending ratio of these sensitizers is too little, the sensitivity decreases while if the blending ratio of these sensitizers is too much, light transmission toward the bottom of the resist is inhibited, so that the form of the cross-section of the resist becomes an inverted trapezium, resulting in a decreased precision of resolution, which is not preferable.

Other components of the photopolymerization initiator used in the present invention include benzoin methyl ether, benzoin ethyl ether, benzoin isopropyl ether, benzyl dimethyl ketal, α-halogenoacetophenones, methylphenyl glyoxylate, benzil, anthraquinone, phenanthrenequinone, camphor quinone isophthalophenone, acylphosphine oxide, α-acyloxime ester, camphor quinone and other compounds. In addition, organoborate-based compounds described in JP-A-2000-249822 may be used.

(4) (D) Thiol Compound Having two or more Mercapto-Group-Containing Groups in which Carbon Atoms at α-Position and/or β-Position with Respect to the Mercapto Group have a Substituent

The thiol compound (D) used in the present invention have two or more mercapto-group-containing groups in which carbon atoms at α-position and/or β-position with respect to the mercapto group have a substituent. Here, it is preferable that at least one of the above-mentioned substituents be an alkyl group.

That is, preferably, the thiol compound (D) is a branched thiol compound that includes a structure of branching on carbon atom(s) at the α-position and/or β-position with respect to the mercapto group, or a branched thiol compounds having a so-called branched structure, in which carbon atoms at α-position and/or β-position with respect to the mercapto group have three or more bonds with atoms other than hydrogen atoms. For example, the thiol compound (D) is, for example, is a thiol compound in which at least one of substituents that is at α-position and/or β-position with respect to the mercapto group in chains other than the main chain is an alkyl group. Here, the main chain represents the longest chain that contains the mercapto group and is constituted by atoms other than hydrogen atoms.

Among them, the thiol compounds in which the above-mentioned mercapto group-containing-group is represented by the following formula (1) are preferable.
—(CH₂)ₘC(R¹)(R²)(CH₂)ₙSH (1)

In the formula (1), R¹ and R² independently represent each a hydrogen atom or an alkyl group, at least one of R¹ and R² is an alkyl group. In other words, R¹ and R² do not represent hydrogen atoms simultaneously. When R¹ and R² are both alkyl groups, they may be the same or different. m is an integer of 0 or 1 to 2, and n is 0 or 1.

The above-mentioned alkyl group (in the formula (1) above, R¹ or R²) is preferably a linear or branched alkyl group. Specific examples thereof include a methyl group, an ethyl group, an n-propyl group, and an iso-propyl group, more preferably a methyl group or an ethyl group.

Note that the thiol compound (D) of the present invention is a multifunctional compound having two or more mercapto-group-containing groups described above. Being multifunctional, the thiol compound (D) of the present invention can provide higher sensitivity than monofunctional compounds can.

Further, the mercapto-group-containing group represented by the formula (1) above preferably assumes a carboxylic acid derivative structure as represented by the following formula. Here, R¹, R², m and n are the same as defined in the formula (1) above.
—O—CO—(CH₂)ₘC(R¹)(R²)(CH₂)ₙSH

The above-mentioned thiol compound (D) is more preferably an ester of a mercapto group-containing carboxylic acid represented by the formula (2) below and an alcohol.
HO—CO—(CH₂)ₘC(R¹)(R²)(CH₂)ₙSH (2)

Here, in the formula (2) above, R¹ and R² independently represent each a hydrogen atom or an alkyl group, at least one of R¹ and R² is an alkyl group. m is an integer of 0 or 1 to 2, and n is 0 or 1. Specific examples of the alkyl group include those described with respect to the formula (1) described above.

Since the thiol compound (D) of the present invention is a multifunctional thiol compound, a multifunctional alcohol is more desirable as the alcohol that is subjected to esterification reaction with the compound of the formula (2). Examples of the multifunctional alcohol include an alkylene glycol (here, the number of carbons of the alkylene group is preferably 2 to 10, and the carbon chain may be branched), diethyleneglycol, glycerin, dipropylene glycol, trimethylolpropane, pentaerythritol, dipentaerythritol, and high molecular polymer having a hydroxyl group.

The high molecular polymer having a hydroxyl group preferably includes an acrylic copolymer having a hydroxyl group. The weight average molecular weight of the high molecular polymer having a hydroxyl group in terms of polystyrene as measured by GPC is not particularly limited, however, preferably 1,000 to 50,000.

Examples of the mercapto-group-containing carboxylic acid of the formula (2) above include 2-mercaptopropionic acid, 3-mercaptobutyric acid, 2-mercaptobutyric acid, 2-mercaptoisobutyric acid, 4-mercaptovaleric acid, and 3-mercaptovaleric acid.

Specific examples of the thiol compound having the structure of the formula (1) above according to the present invention include the following compounds.

Examples of hydrocarbon dithiols include 2,5-hexanedithiol, 2,9-decandithiol and 1,4-bis(1-mercaptoethyl)benzene.

Examples of compound having an ester bond in structure include phthalic acid di(1-mercaptoethyl ester), phthalic acid di(2-mercaptopropyl ester), phthalic acid di(3-mercaptobutyl ester) and phthalic acid di(3-mercaptoisobutyl ester).

Preferred examples thereof include ethylene glycol bis(2-mercaptopropionate), diethylene glycol bis(2-mercaptopropionate), 1,2-propylene glycol. bis(2-mercaptopropionate), 1,2-butanediol bis(2-mercaptopropionate), 1,3-butanediol bis(2-mercaptopropionate), 1,4-butanediol bis(2-mercaptopropionate), 1,8-octanediol bis(2-mercaptopropionate), trimethylolpropane tris(2-mercaptopropionate), pentaerythritol tetrakis(2-mercaptopropionate), dipentaerythritol hexakis(2-mercaptopropionate), ethylene glycol bis(3-mercaptobutyrate), diethylene glycol bis(3-mercaptobutyrate), 1,2-propylene glycol bis(3-mercaptobutyrate), 1,2-butanediol bis(3-mercaptobutyrate), 1,3-butanediol bis(3-mercaptobutyrate), 1,4-butnediol bis(3-mercaptobutyrate), 1,8-octanediol bis(3-mercaptobutyrate), trimethylolpropane tris(3-mercaptobutyrate), pentaerythritol tetrakis(3-mercaptobutyrate), dipentaerythritol hexakis(3-mercaptobutyrate), ethylene glycol bis(2-mercaptoisobutyrate), diethylene glycol bis(2-mercaptoisobutyrate), 1,2-propylene glycol bis(2-mercaptoisobutyrate), 1,2-butanediol bis(2-mercaptoisobutyrate), 1,3-butanediol bis(2-mercaptoisobutyrate), 1,4-butnediol bis(2-mercaptoisobutyrate), 1,8-octanediol bis(2-mercaptoisobutyrate), trimethylolpropane tris(2-mercaptoisobutyrate), pentaerythritol tetrakis (2-mercaptoisobutyrate), dipentaerythritol hexakis(2-mercaptoisobutyrate), ethylene glycol bis(4-mercaptovalerate), diethylene glycol bis(4-mercaptovalerate), 1,2-propylene glycol bis(4-mercaptovalerate), 1,2-butanediol bis(4-mercaptovalerate), 1,3-butanediol bis(4-mercaptovalerate), 1,4-butnediol bis(4-mercaptovalerate), 1,8-octanediol bis(4-mercaptovalerate), trimethylolpropane tris(4-mercaptovalerate), pentaerythritol tetrakis(4-mercaptovalerate), and dipentaerythritol hexakis(4-mercaptovalerate).

The thiol compound (D) preferably includes a thiol compound (a) represented by the following formula (a).
(L-CO—O—CH₂—)₃—C—CH₂—CH₃ (a)

In the formula (a), L is a mercapto-group-containing group represented by the above-mentioned formula (1). That is, the thiol compound (a) has three mercapto-group-containing groups obtained by using trimethylolpropane as the starting material multifunctional alcohol. Note that more preferable examples of thiol compound (a) include those in which the mercapto group is secondary (a-1) and those in which the mercapto group is tertiary (a-2).

(a-1): Thiol compound Obtained by using Trimethylolpropane as a Starting Material Multifunctional Alcohol and Whose Mercapto Group is Secondary

This thiol compound is a thiol compound represented by the general formula (a) above, wherein either one of R¹ and R² in L (which corresponds to the mercapto-group-containing group represented by the formula (1) above) is a hydrogen atom. A preferable specific example of such a thiol compound (a-1) is trimethylolpropane tris(3-mercaptobutyrate) (TPMB).

(a-2): Thiol Compound Obtained by using Trimethylolpropane as a Starting Material Multifunctional Alcohol and Whose Mercapto Group is Tertiary

This thiol-compound is a thiol compound represented by the general formula (a) above, wherein both R¹ and R² in L (which corresponds to the mercapto-group-containing group represented by the formula (1) above) are alkyl groups. A preferable specific example of such a thiol compound (a-2) is trimethylolpropane tris(2-mercaptoisobutyrate) (TPMIB).

The production method for the thiol compound (D) is not particularly limited. Ester of the mercapto group-containing carboxylic acid and an alcohol can be obtained by reacting the mercapto group-containing carboxylic acid represented by the formula (2) described above with an alcohol by a conventional method. The conditions of the esterification reaction are not particularly limited and may be selected appropriately from the conventionally known reaction conditions

By use of a branched multifunctional thiol compound as specified above, a photosensitive composition having high sensitivity and excellent storage stability can be obtained in the present invention. The thiol compounds may be used singly or two or more of them may be used in combination.

(5) (E) Organic Solvent

The organic solvent used in the present invention is not particularly limited so far as it dissolves or disperses the above-mentioned respective components that constitute the photosensitive composition for color filter black matrix resists of the present invention. Specific examples thereof include methanol, ethanol, isopropanol, toluene, xylene, ethylbenzene, cyclohexane, isophorone, cellosolve acetate, diethylene glycol dimethyl ether, ethylene glycol diethyl ether, methyl cellosolve, ethyl cellosolve, butyl cellosolve, propylene glycol monomethyl ether, propylene glycol monomethyl ether acetate, propylene glycol monoethyl ether acetate, diethylene glycol ethyl ether acetate, methyl methoxypropionate, ethyl methoxypropionate, methyl ethoxypropionate, ethyl ethoxypropionate, ethyl acetate, isoamyl acetate, ethyl lactate, acetone, methyl ethyl ketone, cyclohexanone, N,N-dimethylformamide, and N-methylpyrrolidone. These may be used singly or two or more of them may be used in combination.

The photosensitive composition for color filter black matrix resists of the present invention is desirably conditioned such that the concentration of solid content is 5 to 30 mass %, preferably 10 to 25 mass % by use of these organic solvents.

(6) (F) Black Pigment

As for the black pigment (F) used in the color filter black matrix resist composition of the present invention, carbon black, acetylene black, lamp black, graphite, iron black, aniline black, cyanine black, titanium black are exemplified, or red, green and blue organic pigments can be mixed and used as black pigment. Among them, carbon black is particularly preferable from the viewpoint of light shielding ratio and image characteristics.

Examples of the carbon black include the following ones. Manufactured by Mitsubishi Chemical Corporation: MA7, MA8, MA11, MA100, MA220, MA230, #52, #50, #47, #45, #2700, #2650, #2200, #1000, #990, #900. Manufactured by Degussa: Printex 95, Printex 90, Printex 85, Printex 75, Printex 55, Printex 45, Printex 40, Printex 30, Printex3, Printex A, Printex G, Special Black 4, Special Black 550, Special Black 350, Special Black 250, Special Black 100. Manufactured by Cabot Corporation: Monarch 460, Monarch 430, Monarch 280, Monarch 120, Monarch 800, Monarch 4630, REGAL 99, REGAL 99R, REGAL 415, REGAL 415R, REGAL 250, REGAL250R, REGAL 330, BLACK PEARL S480, PEARL S130. Manufactured by Columbian Carbon Co.: Raven 11, Raven 15, Raven 30, Raven 35, Raven 40, Raven 410, Raven 420, Raven 450, Raven 500, Raven 780, Raven 850, Raven 890H, Raven 1000, Raven 1020, Raven 1040, Raven 1060, Raven 1080, Raven 1255.

The above-mentioned carbon blacks may be used in combination with other black inorganic or organic pigments.

(7) Other Optional Components

The color filter black matrix resist composition of the present invention may contain, in addition to these essential components, a pigment dispersant, an adhesion improver, a leveling agent, a development improver, an antioxidant, a heat polymerization inhibitor and so forth. In particular, in the case of the color filter black matrix resist composition of the present invention, it is important that the coloring material is finely dispersed and the dispersion state is stabilized for obtaining stable quality and therefore, it is in some cases desirable that a pigment dispersant is blended.

The pigment dispersant has affinity for both pigment and binder resin, and examples thereof include surfactants such as nonion, cation and anion, and polymer dispersants. Among these, polymer dispersants are preferable. In particular, polymer dispersants having functional groups such as primary, secondary or tertiary amino groups, basic functional groups such as pyridine, pyrimidine, pyrazine and the like nitrogen-containing heterocyclic rings or amide groups, and urethane groups are advantageously used.

Specific examples of the heat polymerization inhibitor that is added for the purpose of preventing polymerization during storage include p-methoxyphenol, hydroquinone, catechol, tert-butylcatechol, phenothiazine, and methoquinone.

Further, depending on the purpose, a fluorescent brightener, a surfactant, a plasticizer, a flame retardant, an ultraviolet absorbent, a foaming agents a fungicide, antistatic agent, a magnetic substance, an electro conducting material, an antifungal or antibacterial material, a porous adsorbent, a fragrant material and the like may be added.

(8) Blending Ratios

The blending ratios of the respective constituent components in the photosensitive composition for color filter black matrix resists of the present invention are not particularly limited; however, ratios of the components are preferably set to the following ratios based on the total amount (total solid content) of the components excluding

(E) The Organic Solvent.

The blending ratio of (A) binder resin having a carboxyl group is within 30 to 70 mass %, preferably 35 to 65 mass %. If the amount of the binder resin is too small, there are defects that adhesion to the substrate is deteriorated or the alkali developability of the photocured portion is decreased. On the other hand, if the amount of the binder resin is too large, there is a defect that light shielding property is deteriorated.

The blending ratio of (B) the compound having an ethylenically unsaturated group is within 5 to 40 mass %, preferably 10 to 30 mass %. If the amount of the compound having an ethylenically unsaturated group is too small, there is a defect that the photosensitivity is decreased while if the amount of that compound is too large, there is a defect that resist patterns tend to become broader than the line width of the photomask.

The blending ratio of (C) the photopolymerization initiator is within 3 to 30 mass %, preferably 5 to 20 mass %. If the amount of the photopolymerization initiator is too small, there is a defect that the photosensitivity is decreased while if the amount of the photopolymerization initiator is too large, there is a defect that resist patterns tend to become broader than the line width of the photomask.

The blending ratio of (D) the thiol compound having two or more mercapto-group-containing groups in which carbon atoms at α-position and/or β-position have a substituent is within 3 to 30 mass %, preferably 5 to 20 mass %. If the ratio of the thiol compound is too small, there is a defect that the photosensitivity is decreased while if the ratio of the thiol compound is too large, there is a defect that resist patterns tend to become broader than the line width of the photomask.

Further, in the resist composition of the present invention, in the case where the photosensitive composition contains a black pigment (F) in addition to the above-mentioned components, the blending ratios of the respective constituent components with respect to the total amount (total solid content) of the components excluding the organic solvent (E) are preferably set as follows.

The blending ratio of (A) the binder resin having a carboxyl group is within 10 to 30 mass %, preferably 15 to 25 mass %. If the amount of the binder resin is too small, there is a defect that the adhesion to the substrate is deteriorated. On the other hand, if the amount of the binder resin is too large, there is a defect that the light shielding property is deteriorated.

The blending ratio of (B) the compound having an ethylenically unsaturated group is within 2 to 20 mass %, preferably 3 to 15 mass %. If the amount of the compound having an ethylenically unsaturated group is too small, there is a defect that the photosensitivity is decreased while if the amount of that compound is too large, there is a defect that resist patterns tend to become broader than the line width of the photomask.

The blending ratio of (C) the photopolymerization initiator is within 2 to 15 mass %, preferably 5 to 10 mass %. If the amount of the photopolymerization initiator is too small, there is a defect that the photosensitivity is decreased while if the amount of the photopolymerization initiator is too large, there is a defect that resist patterns become broader than the line width of the photomask.

The blending ratio of (D) the thiol compound having two or more mercapto-group-containing groups in which carbon atoms at α-position and/or β-position have a substituent is within 2 to 15 mass %, preferably 5 to 10 mass %. If the ratio of the thiol compound is too small, there is a defect that the photosensitivity is decreased while if the ratio of the thiol compound is too large, there is a defect that resist patterns become broader than the line width of the photomask.

The blending ratio of (F) the black pigment is within 40 to 70 mass %, preferably 45 to 65 mass %. If the ratio of the amount of the black pigment is too small, there is a defect that the light shielding property is deteriorated while if the amount of the black pigment (F) is too large, there is a defect that the photosensitivity is decreased or adhesion to the substrate is deteriorated.

(9) Production Method

The photosensitive composition of the present invention can be produced by mixing or premixing (A) a binder resin having a carboxyl group, (E) an organic solvent, (F) a black pigment, and optionally a pigment dispersant, performing dispersing treatment, and further mixing and dissolving (B) a compound having an ethylenically unsaturated group, (C) a photopolymerization initiator, and (D) a thiol compound having two or more mercapto-group-containing groups in which carbon atoms at α-position and/or β-position have a substituent.

The dispersing machines for performing dispersing treatment include roll mills such as a two-roll mill and a three-roll mill, ball mills such as a ball mill and a vibrating ball mill, a paint conditioner and bead mills such as a continuous disk type bead mill and a continuous annular type bead mill. A continuous annular type bead mill is particularly preferable in that pulverization and dispersion is achieved in a short period of time, that particle size distribution after the dispersion is sharp, and that it is easy to control the temperature during pulverization and dispersion so that properties of the dispersion can be prevented from changing.

The continuous annular type bead mill is of a structure having a vessel (cylindrical body) provided with an inlet and an outlet for a material and a rotor (rotating body) formed with grooves for stirring beads, inserted into the vessel. In a gap portion between the double cylinders which the vessel and the rotor constitute, beads are imparted movement by the rotation of the rotor to effect pulverization, shearing and grinding, so that the black pigment can be efficiently pulverized and dispersed. The sample is introduced through the inlet on one end of the vessel and converted into fine particles and discharged through the outlet on the side opposite to the inlet part and this procedure is repeated until a necessary particle size distribution can be obtained. The time in which the sample is substantially subjected to pulverizing and dispersing treatment within the vessel is called retention time.

Examples of such continuous annular type mead mill include Spike Mill (trade name) manufactured by Inoue Seisakusho Co., Ltd. and OB-Mill (trade name) manufactured by Turbo Kogyo Co., Ltd.

Preferable dispersion conditions for the continuous annular type bead mill are as follows. The size (diameter) of beads to be used is preferably 0.2 to 1.5 mm, more preferably 0.4 to 1.0 mm. If the size of the beads is less than 0.2 mm, the weight of a single bead becomes too small so that the pulverization energy a single bead has becomes low so that pulverization of the pigment is difficult to proceed. If the size of the beads exceeds 1.5 mm, collision frequency between the beads is reduced so that it becomes difficult to perform pulverization of carbon black in a short period of time. The material of bead is preferably a ceramic such as zirconia or alumina, or stainless steel, having specific gravity of 4 or more, to enhance the pulverization efficiency.

The peripheral speed of the rotor is preferably 5 to 20 m/second, more preferably 8 to 15 m/second. If the peripheral speed is less than 5 m/second, the pulverization or dispersion of the pigment cannot be performed efficiently. If the peripheral speed of the rotor exceeds 20 m/second, the temperature of the pigment dispersion becomes too high due to friction heat, to unpreferably cause denaturation in properties such as increase in viscosity. The temperature during dispersing is preferably within the range of 10 to 60° C., more preferably room temperature to 50° C. The temperature of less than 10° C. is not preferable since the moisture in the atmosphere is mixed in the dispersion due to dew formation. On the other hand, the temperature exceeding 60° C. unpreferably causes denaturation in properties such as increase in viscosity.

The retention time is preferably 1 to 30 minutes, more preferably 3 to 20 minutes. If the retention time is shorter than 1 minute, pulverizing and dispersing treatment be comes insufficient while if the retention time exceeds 30 minutes, denaturation of the dispersion occurs, resulting in an increase in viscosity.

(10) Production Method for a Color Filter

The production method for color filters using the color filter black matrix resist composition of the present invention will be described taking an example of a color filter for a liquid crystal display which is formed by laminating a black matrix resist composition, pixels, and a protective film in this order.

The color filter black matrix resist composition of the present invention is coated onto a transparent substrate. Then, after the solvent is dried in an oven or the like, the resultant is exposed through a photomask and developed to form a black matrix pattern, followed by post-baking to complete a black matrix.

Here, the transparent substrate is not particularly limited and inorganic glasses such as silica glass, borosilicate glass, and lime soda glass coated with silica on its surface, films or sheets of polyesters such as polyethylene terephthalate, polyolefins such as polypropylene and polyethylene, thermoplastic plastics such as polycarbonate, polymethyl methacrylate, and polysulfones, thermosetting resins such as epoxy resins and polyester resins are preferably used. Such transparent substrates may have been subjected to corona discharge treatment, ozone treatment, thin film forming treatment of various polymers such as silane coupling agent, urethane polymer, and so forth.

In addition to dip coating, roll coater, a wire bar, a flow coater, a die coater, and a spray coating, a rotation coating method such as spinner is used advantageously.

The solvent is dried in a drying apparatus such as a hot plate, an IR oven, or a convection oven. Preferable drying conditions are 40 to 150° C. for a drying time in the range of 10 seconds to 60 minutes. Also, the solvent may be dried in a vacuum state.

The exposure method is as follows. After a gap of 50 to 200 μm is provided above the sample, a photomask is placed thereon and image-wise exposure through the photomask is performed. Examples of the light source used for the exposure include lamp light sources such as a xenon lamp, a high pressure mercury lamp, a super high pressure mercury lamp, a metal halide lamp, a medium pressure mercury lamp, and a low pressure mercury lamp, and laser light sources such as an argon ion laser, a YAG laser, an excimer laser, and a nitrogen laser. When only light with a specified wavelength of the irradiated light is used, an optical filter may be used.

The development treatment is performed by developing a resist (which refers to a color filter black matrix resist composition or cured product thereof, hereinafter the same is true) using a developing solution by a dip, shower, or paddle method or the like. The developing solution is not particularly limited so far as it is a solvent that can dissolve unexposed portion of a resist film. For example, acetone, methylene chloride, trichlene, cyclohexanone and the like organic solvents may be used. However, many of organic solvents cause environmental pollution, have toxicity to human body, and have a risk of causing fire, so that it is preferable to use alkali developers free from such risks. Examples of such alkali developer include aqueous solutions containing inorganic alkali agents such as sodium carbonate, potassium carbonate, sodium silicate, potassium silicate, sodium hydroxide, and potassium hydroxide, or organic alkali agents such as diethanolamine, triethanolamine and tetaralkylammonium hydroxide. The alkali developer may contain a surfactant, a water-soluble organic solvent, a low molecular compound having a hydroxyl group or a carboxyl group, as necessary. In particular, surfactants, many of which have effects of improving developability, resolution, and stain, can be preferably added to the alkali developer.

Examples of surfactant for developing solution include anionic surfactants having a sodium naphthalenesulfonate group or a sodium benzenesulfonate group, nonionic surfactants having a polyalkyleneoxy group, and cationic surfactants having a tetraalkylammonium group.

The developing process is not particularly limited, however, developing is performed usually at a temperature of 10 to 50° C., preferably 15 to 45° C. by a dipping development method, a spray development method, a brush development method, a supersonic development method or the like.

The post baking is performed using the same apparatus as used for the solvent drying in a temperature range of 150 to 300° C. for 1 to 120 minutes. The post baking is performed in order to make the curing reaction of the resist composition more complete by heat.

The black matrix thus obtained may advantageously have a film thickness in the range of 0.1 to 1.5 μm, preferably 0.2 to 1.2 μm and further it is preferable that the optical density of the black matrix at such film thickness be 3 or more in order to function as a black matrix.

The black matrix pattern prepared in this step has an opening on the order of 20 to 200 μm between black matrices. In a later step, pixels are formed in this opening space.

Then, a plurality of color pixels are formed in the opening of the black matrix. Usually, the colors of the pixels are three colors, i.e., red (R), green (G), and blue (B). The photosensitive composition is colored with a pigment or dye. First, the photosensitive composition is coated onto the transparent substrate on which the black matrix pattern is mounted. Then, a solvent is dried in an oven or the like so that a colored layer of a first color is formed on the entire surface of the blackmatrix. Usually, a color filter includes pixels of a plurality of colors; unnecessary portions are removed by a photolithographic method to form a pixel pattern in the desired first color. The thickness of the pixel is on the order of 0.5 to 3 μm. This procedure is repeated by the number of times equal to the number of required colors to form pixels having a plurality of colors and thus a color filter is produced. Although it is preferable that the apparatus and chemicals used in the step for forming each pixel are the same as those used for forming the black matrix, there is no problem if they are different.

Thereafter, a protective layer is laminated as necessary. The protective layer may be made of acrylic resins, epoxy resins, silicone resins, polyimide resins or the like and is not particularly limited.

Further, other than the above method, there is a so-called backside exposure method, that is, a method in which after patterned pixels are preliminarily formed on a transparent substrate, the opposite side (backside) of the transparent substrate is coated with a black matrix resist composition, and then the transparent substrate is exposed to light from the front side to form a black matrix between the pixels using the pixels as masks.

Finally, lamination and patterning of an ITO (indium-tin oxide) transparent electrode is performed by a general method as necessary.

### BEST MODE FOR CARRYING OUT THE INVENTION

Hereinafter, the present invention will be described by means of Examples. However, the present invention is not limited to the Examples. In the Examples, “part” means mass part and “%” means mass %. Note that the prepared photosensitive composition is called “resist” for the sake of simplicity.

### SYNTHESIS EXAMPLE 1

### Synthesis of Acrylic Copolymer (AP-1) Having a Carboxyl Group

In a four-necked flask equipped with a dropping funnel, a thermometer, a condenser tube and a stirrer, 37.5 mass parts of methacrylic acid (MA), 19.0 mass parts of methyl methacrylate (MMA), 18.5 mass parts of n-butyl methacrylate (BMA), 0.75 mass part of 2-mercaptoethanol, and 225.0 mass parts of propylene glycol methyl ether (PGM) were charged, and the inside of the four-necked flask was purged with nitrogen for one hour. Further, the temperature was elevated to 90° C. in an oil bath, and then a mixture of 37.5 mass parts of MA, 19.0 mass parts of MMA, 18.5 mass parts of BMA, 0.75 mass part of 2-mercaptoethanol, 225.0 mass parts of PGM, and 3.2 mass parts of 2,2′-azobisisobutyronitrile (AIBN) was dripped over 1 hour. After polymerization was performed for 3 hours, the mixture was heated to 100° C. and a mixture of 1.0 mass part of AIBN and 15.0 mass parts of propylene glycol methyl ether acetate (PMA) was added, and then polymerization was performed for additional 1.5 hours, followed by standing to cool. Thereafter, the inside of the four-necked flask was air-purged, and 61.5 mass parts of glycidyl methacrylate (GMA), 3.6 mass parts of tetra-n-butylammonium bromide (TBAB), and 0.15 mass part of methoquinone were added. The reaction was performed at 80° C. for 8 hours to add GMA to the carboxyl group of the acrylic copolymer. The obtained GMA-added acrylic copolymer was named AP-1. AP-1 had a solid content concentration of 30.5%, a solid content acid value of 116 mgKOH/g, and a weight average molecular weight of 14,000 in terms of polystyrene as measured by GPC.

### SYNTHESIS EXAMPLE 2

### Synthesis of Acrylic Copolymer (AP-2) Having a Carboxyl Group

In a four-necked flask equipped with a dropping funnel, a thermometer, a condenser tube and a stirrer, 17.5 mass parts of MA, 30.0 mass parts of MMA, 7.5 mass parts of benzyl methacrylate (BzMA), 20.0 mass parts of 2-hydroxyethyl methacrylate (HEMA), 0.75 mass part of 2-mercaptoethanol, and 225.0 mass parts of PMA were charged and the inside of the four-necked flask was nitrogen-purged. Further, the temperature was elevated to 90° C. in an oil bath, and then a mixture of 17.5 mass parts of MA, 30.0 mass parts of MMA, 7.5 mass parts of BzMA, 20.0 mass parts of HEMA, 75 mass part of 2-mercaptoethanol, 225.0 mass parts of PMA, and 3.2 mass parts of AIBN was dripped over 1 hour. After polymerization was performed for 3 hours, the mixture was heated to 100° C. and a mixture of 1.0 mass part of AIBN and 15.0 mass parts of PMA was added, and then polymerization was performed for additional 1.5 hours, followed by decreasing the temperature to 60° C. Thereafter, the inside of the four-necked flask was air-purged, and 48.0 mass parts of 2-methacryloyloxyethyl isocyanate (MEI) manufactured by SHOWA DENKO K.K., 0.15 mass part of dibutyltin dilaurate and 0.15 mass part of methoquinone were added and reaction was performed at 60° C. for 5 hours to add MEI to the hydroxyl group of the acrylic copolymer. The obtained MEI-added acrylic copolymer was named AP-2. AP-2 had a solid content concentration of 29.5%, a solid content acid value of 114mgKOH/g, and a weight average molecular weight of 13,000 in terms of polystyrene as measured by GPC.

### SYNTHESIS EXAMPLE 3

### Synthesis of Dispersant (DP-1)

In a four-necked flask equipped with a reflux condenser, a thermometer, a stirrer, and a dropping funnel, 40 mass parts of cyclohexanone was charged and the liquid temperature was maintained at 100° C. Under nitrogen atmosphere, a mixed solution consisting of 12 mass parts of NK Ester M-20G (methoxydiethylene glycol methacrylate) manufactured by Shin-Nakamura Chemical Co., Ltd., 4 mass parts of Macromonomer AA-6 (methyl methacrylate macromonomer) manufactured by Toa Gosei Co., Ltd., 8 mass parts of Light Ester DQ-100 (dimethylaminoethyl methacrylate, quaternarized product) manufactured by Kyoeisha Chemical Co., Ltd., 16 mass parts of Light Ester DM (dimethylaminoethyl methacrylate) manufactured by Kyoeisha Chemical Co., Ltd., 0.4 mass part of n-dodecylmercaptan, 0.8 mass part of AIBN and 20 mass parts of cyclohexanone was dripped over about 3 hours. After completion of the dropping, further 0.5 mass part of AIBN was added and reaction was performed at 100° C. for 2 hours. The weight average molecular weight of the obtained copolymer measured in terms of polystyrene by GPC was 20,000. The solid content concentration was 40.0%. This dispersant was named DP-1.

### SYNTHESIS EXAMPLE 4

### Synthesis of Photopolymerization Initiator Component “2,2′-bis(2-chlorophenyl)-4,4′,5,5′-tetrakis(4-methylphenyl)-1,2′-biimidazole (MHABI)”

In a 1-L volume egg-plant shaped flask, 27.50 g (115 mmol) of 4,4′-dimethylbenzil, 16.25 g (116 mmol) of o-chlorobenzaldehyde, 69.45 g (901 mmol) of ammonium acetate, and 450 g of acetic acid were introduced and reaction was performed at 117° C. for 5 hours while stirring. After standing to cool, the reaction mixture was slowly charged in 2 L of deionized water being stirred and 2-chlorophenyl-4,5-bis(4-methylphenyl)imidazole was precipitated. Thereafter, 2-chlorophenyl-4,5-bis(4-methylphenyl)imidazole was filtered and washed with water and then dissolved in 500 g of methylene chloride. The solution was charged in a 2 L volume four-necked flask and cooled to 5 to 10° C. To this was added a mixed solution consisting of 117.6 g (357 mmol) of potassium ferricyanide, 44.7 g of sodium hydroxide, and 600 g of deionized water over 1 hour while stirring. Further, reaction was performed at room temperature for 18 hours. The reaction mixture was washed with deionized water 3 times and then dehydrated over about 50 g of anhydrous magnesium sulfate, followed by evaporation of methylene chloride under reduced pressure. As a result, crystals of MHABI were formed. MHABI was recrystallized from ethanol, filtered, and dried. As a result, 36.5 g (yield 88.7%) of pale yellow crystals were obtained.

### SYNTHESIS EXAMPLE 5

### Synthesis of Photopolymerization Initiator Component “1,2-propylene glycol bis(3-mercaptobutyrate) (PGMB)”.

In a 100 mL volume egg-plant shaped flask, 3.04 g (40 mmol) of 1,2-propylene glycol, 10.57 g (88.mmol) of 3-mercaptobutanoic acid, 0.61 g (3.2 mmol) of p-toluenesulfonic acid monohydrate, and40g of toluene were charged and a Dean-Stark apparatus and a condenser tube were attached to the flask. The content of the flask was heated at an oil bath temperature of 140° C. while stirring. After 2 hours from the start of the reaction, 0.61 g (3.2 mmol) of p-toluenesulfonic acid monohydrate was added and then 0.30 g (1.6 mmol) of p-sulfonic acid monohydrate was added after 4 hours from the start of the reaction. Further, the reaction was continued for another 1 hour and the reaction mixture was left to cool, followed by neutralizing the reaction mixture with 100 ml of an aqueous 10% sodium hydrogen carbonate solution. Further, the reaction mixture was washed with deionized water 3 times and dehydrated and dried over anhydrous magnesium sulfate. Then, toluene was evaporated and the residue was subjected to silica gel column chromatography to purify PGMB. Wako GELC-200 (manufactured by Wako Pure Chemical Industries Co., Ltd.) was used as a silica gel and n-hexane/ethyl acetate=6:1 (volume ratio) was used as elution solvent. PGMB obtained after the purification was a colorless transparent liquid. The yield was 2.80 g and percent yield was 25%.

### SYNTHESIS EXAMPLE 6

### Synthesis of Photopolymerization Initiator Component “trimethylolpropane tris(3-mercaptobutyrate) (TPMB)”

In a 100 mL volume egg-plant shaped flask, 2.68 g (20 mmol) of trimethylolpropane, 7.57 g (63 mmol) of 3-mercaptobutanoic acid, 0.23 g (1.2 mmol) of p-toluenesulfonic acid monohydrate and 20 g of toluene were charged and a Dean-Stark apparatus and a condenser tube were attached to the flask. The content of the flask was heated at an oil bath temperature of 145° C. while stirring. After 3 hours from the start of the reaction, the reaction mixture was left to cool, followed by neutralizing the reaction mixture with 50 ml of an aqueous 5% sodium hydrogen carbonate solution. Further, the reaction mixture was washed with deionized water 2 times and dehydrated and dried over anhydrous magnesium sulfate. Then, toluene was evaporated and the residue was subjected to silica gel column chromatography to purify TPMB. Wako GELC-200 (manufactured by Wako Pure Chemical Industries Co., Ltd.) was used as silica gel and n-hexane/ethyl acetate=5:1 (volume ratio) was used as elution solvent. TPMB obtained after the purification was a colorless transparent liquid. The yield was 5.63 g and percent yield was 64%.

### SYNTHESIS EXAMPLE 7

### Synthesis of Photopolymerization Initiator Component “trimethylolpropane tris(2-mercaptoisobutyrate) (TPMIB)”

In a 100 mL volume egg-plant shaped flask, 2.68 g (20 mmol) of trimethylolpropane, 7.57 g (63 mmol) of 2-mercaptoisobutanoic acid, 0.23 g (1.2 mmol) of p-toluenesulfonic acid monohydrate, and 20 g of toluene were charged and a Dean-Stark apparatus and a cooling pipe were attached to the: flask. The contents were heated on an oil bath at an oil bath temperature of 145° C. while stirring. After 3 hours from the start of the reaction, the reaction mixture was left to cool, followed by neutralizing the reaction mixture with 50 ml of an aqueous 5% sodium hydrogen carbonate solution. Further, the reaction mixture was washed with deionized water 2 times and dehydrated and dried over anhydrous magnesium sulfate. Then, toluene was evaporated and the residue was subjected to silica gel column chromatography to purify TPMIB. Wako GEL C-200 (manufactured by Wako Pure Chemical Industries Co., Ltd.) was used as silica gel and n-hexane/ethyl acetate=5:1 (volume ratio) was used as elution solvent. TPMIB obtained after the purification was white crystal. The yield was 4.50 g and percent yield was 51%.

Dispersion-I: Preparation of a Carbon Black Dispersion

After mixing 438 mass parts (solid content 210 mass parts) of Cyclomer ACA-200 (hereinafter, abbreviated as ACA-200) manufactured by Daicel Chemical Industries, Ltd., (solid content concentration 48%, weight average molecular weight in terms of polystyrene 19,000, solid content acid value 116 mg/g), which is an acrylic copolymer having an acryloyl group and a carboxyl group in a side chain, 210 mass parts (solid content 84 mass parts) of DP-1, the copolymer dispersant obtained in Synthesis Example 3, 546 mass parts of Special Black 250 (manufactured by Degussa) as carbon black, and 3,000 mass parts of cyclohexanone, the resultant was premixed using a disperser. Further, this mixed solution was dispersed in a continuous annular type bead mill (trade name:Spike Mill Model SHG-4, manufactured by Inoue Seisakusho Co., Ltd.). The beads used were zirconia beads having a diameter of 0.65 mm and the filling ratio of the beads in the vessel was set to 80 volume %. The peripheral speed of the rotor was 12 m/second, the discharge rate of the carbon black dispersion was 1 liter/minute, and the temperature was set to about 30° C. The retention time of the carbon black dispersion in the vessel was set to 6 minute (for operation time of 1 hour). Dispersion-1 was thus obtained.

In a manner similar to the above, Carbon Black Dispersions-2 to -6 having the compositions shown in Table 1 were obtained.

TABLE 1
Blending Composition of Carbon Black Dispersion(Mass Part)

| | Acrylic | | | | |
|---|---|---|---|---|---|
| | Copolymer | Dispersant | Carbon Black | Organic Solvent | Total |
| Dispersion-1 | ACA-200 | DP-1 | Special Black 250 | Cyclohexanone | 4194 (840) |
| | 438 | 210 (84) | 546 (546) | 3000 | |
| | (210) | | | | |
| Dispersion-2 | ACA-200 | DP-1 | Raven 1040 | Cyclohexanone | 4194 (840) |
| | 438 | 210 (84) | 546 (546) | 3000 | |
| | (210) | | | | |
| Dispersion-3 | ACA-200 | DP-1 | Raven 1080 | Cyclohexanone | 4194 (840) |
| | 438 | 210 (84) | 546 (546) | 3000 | |
| | (210) | | | | |
| Dispersion-4 | AP-1 | DP-1 | Raven 1060 | Cyclohexanone | 4195 (840) |
| | 689 | 210 (84) | 546 (546) | 2750 | |
| | (210) | | | | |
| Dispersion-5 | AP-1 | DP-1 | Raven 1080 | Cyclohexanone | 4195 (840) |
| | 689 | 210 (84) | 546 (546) | 2750 | |
| | (210) | | | | |
| Dispersion-6 | AP-2 | DP-1 | Raven 1080 | Cyclohexanone | 4193 (840) |
| | 712 | 210 (84) | 546 (546) | 2725 | |
| | (210) | | | | |

*In the parentheses( ) Solid content composition is shown.
Special Black 250 (manufactured by Degussa): Primary particle diameter 56 nm, Specific surface area 40BET-m²/g, DBP oil absorption 40 ml/100 g
Raven 1040 (manufactured by Columbian Carbon Co): Primary particle diameter 28 nm Specific surface area 92BET-m²/g, DBP oil absorption 100 ml/100 g
Raven 1060 (manufactured by Columbian Carbon Co): Primary particle diameter 30 nm, Specific surface area 66BET-m²/g, DBP oil absorption 50 ml/100 g
Raven 1080 (manufactured by Columbian Carbon Co): Primary particle diameter 28 nm, Specific surface area 84BET-m²/g, DBP oil absorption 60 ml/100 g

Evaluation of Black Matrix Resist:

The following reagents were used.

Compound Having an Ethylenically Unsaturated Group (Monomer) (B)

Dipentaerythritol hexaacrylate (hereinafter, abbreviated as DPHA: manufactured by Toa Gosei Co., Ltd.),

Photopolymerization Initiator (C)

(1) 4,4′-Bis(N,N-diethylamino)benzophenone (hereinafter, abbreviated as EMK: manufactured by Hodogaya Chemicals Co. Ltd.
(2) 2-Methyl-1-[4-(methylthio)phenyl]-2-morpholinopropan-1-one (trade name: Irgacure 907: manufactured by Chiba Specialty Chemicals K.K.)
(3) 2-Benzyl-2-dimethylamino-1-(4-morpholinophenyl)-1-butanone-1 (trade name: Irgacure 369: manufactured by Chiba Specialty Chemicals K.K.)
   Thiol Compound (D)
(1) Trimethylolpropane tris(3-mercaptopropionate) (hereinafter, abbreviated as TPMP: manufactured by Yodo Kagaku Co., Ltd.)
(2) 2-Mercaptobenzothiazole (hereinafter, abbreviated as MBT: manufactured by Tokyo Kasei Kogyo Co., Ltd.
   Organic Solvent (E)

Cyclohexanone (manufactured by Wako Pure Chemical Industries Co., Ltd.).

### EXAMPLE 1

### Preparation of black Matrix Resist

Dispersion I (420 mass parts, containing 21.0 mass parts of acrylic copolymer as solid content, 8.4 mass parts of dispersant, and 54.6 mass parts of carbon black), DPHA (8.4 mass parts) as a monomer, EMK (1.0 mass part) as a photopolymerization initiator, MHABI (5.0 mass parts), TPMB (5.0 mass parts) as a multifunctional thiol compound, cyclohexanone (150 mass parts) were mixed and stirred for 2 hours, and then filtered through a filter having a pore diameter of 0.8 μm (filter for GFP manufactured by Kiriyama Glass Works Co.) to prepare a black matrix resist of Example 1.

### EXAMPLE 2 to 6 and COMPARATIVE EXAMPLES 1 and 2

Black matrix resist compositions of Examples 2 to 6 and Comparative Examples 1 and 2 were prepared using the compositions shown in Table 2 and by the same method as that in Example 1.

Measurement of Photosensitivity:

The black matrix resist compositions of Examples 1 to 6 and Comparative Examples 1 and 2 were spin-coated onto glass substrates (size: 100×100×1 mm) to a dry thickness of about 1 μm and left to stand at room temperature for 30 minutes. Thereafter, the solvent was dried at 70° C. for 20 minutes. After the thickness of each resist was preliminarily measured using a film thickness gauge (manufactured by Tokyo Seimitsu Co., Ltd., SURFCOM 130A), the resist was photocured through a quartz made photomask in a photolithography machine having incorporated therein a super high pressure mercury lamp (manufactured by Ushio Inc., trade name: Multilight ML-251A/B) by automatically varying the exposure amount stepwise. The exposure amount was measured using an ultraviolet integral actinometer (manufactured by Ushio Inc., trade name: UIT-150, light receiving part UVD-S365). The quarts made photomask used had formed therein with line/space patterns of 5, 7, 10, 30, 50, 70, or 100 μm.

The exposed resist was alkali-developed with an aqueous solution (25° C.) containing 0.25% of Developer 9033 (manufactured by Shipley Far East Ltd.) which contains potassium carbonate and 0.03% of sodium dodecylbenzenesulfonate for a predetermined time (the developing time was set to double the time (tD) required for the film before exposure to be completely dissolved by alkali development; in the present Example, tD was 15 seconds). After the alkali development, the glass substrates were washed and then dried by air spray. The thickness of the resist films that remained was measured and the ratio of the remaining film was calculated. The remaining film ratio was calculated according to the following formula. photocuring operations were performed in the same manner by varying the exposure amount and the relationship between the exposure amount and remaining film ratio was plotted in a graph, and the exposure amount at which the remaining film ratio reached saturation was obtained.
Remaining film ratio (%)={(film thickness after alkali development)/(film thickness before alkali development)}×100

Next, the line width of the resist formed at a portion where the line/space of the photomask was 10 μm was measured under an optical microscope (manufactured by Keyence Corporation, VH-Z250). The minimum exposure amount at which the remaining film ratio after alkali development reached saturation and the same line width as that of the photomask was obtained by the above-mentioned method was defined as the photosensitivity of the black matrix resist. The results obtained are shown in Table 2.

Measurement of Resolution:

In the evaluation of photosensitivity described above, each black matrix resist was photocured with an exposure amount that correspondeds to its photosensitivity, alkali developed in the same manner as described above and observed under an optical microscope. The minimum line width that remained and was equivalent to the line width of the photomask was defined as resolution of the black matrix resist. The results obtained are shown in Table 2.

OD Value (Optical Density):

The black matrix resist compositions of Examples 1 to 6 and Comparative Examples 1 and 2 were spin-coated onto glass substrates (size: 100×100mm), and dried at room temperature for 30 minutes, followed by drying the solvent at 70° C. for 20 minutes. After photocuring at exposure amounts corresponding to photosensitivity of the respective resists, the resists were post-baked at 200° C. for 30 minutes, and the resulted resist-coated glass substrates were used to measure OD values. The OD values were determined using a calibration curve prepared by measuring a transmittance at 550 nm using a standard plate whose OD value is already known. The results obtained are shown in Table 2.

Storage Stability:

The photosensitivities of the resist compositions of Examples 1 to 6 and Comparative Examples 1 and 2 immediately after they were prepared were measured by the above-mentioned method. In addition, after the preparation, the samples were stored at room temperature for 4 weeks in the dark and the photosensitivities of each example and comparative example were measured. The results are shown in Table 2.

From Table 2, it is apparent that use of thiol compounds having two or more mercapto-group-containing groups in which carbon atoms at the α-position and/or β-position with respect to the mercapto group have a substituent results in obtaining balanced photosensitivity and storage stability, and in addition satisfactory characteristics as a black matrix resist.

That is, in the case of monofunctional thiols, the photosensitivity is low and storage stability is poor (Comparative Example 2), and also, although higher sensitivity can be achieved by using a conventional linear type thiol (laurylmercaptan, octanethiol, HSCH₂CH₂COOH derivatives, etc.), the storage stability is not sufficiently improved (Comparative Example 1). It is only by use of the thiol compound of the present invention that has a so-called branched structure at the α-position and/or β-position in combination with existing photopolymerization initiator in photosensitive composition (Examples 1 to 6) high sensitivity can be maintained and storage stability can be improved.

In the case of photocuring by radical polymerization, complete curing is difficult to occur at the interface with air due to oxygen in the air inhibiting the polymerization. Accordingly, it is a usual practice to provide an air-shielding layer such as a cover film so as to prevent the surface from contacting air, or to perform photocuring under atmosphere of an inert gas such as argon gas or nitrogen. In contrast, the photosensitive composition of the present invention exhibits sufficient curing properties regardless of whether oxygen exists or not and can be used as a photosensitive composition for color filters for which it is preferable to use no oxygen shielding film.

TABLE 2
Results of Evaluation of Black Matrix Resist

| | | | | | | | | Item of Evaluation | | | | |
|---|---|---|---|---|---|---|---|---|---|---|---|---|
| | | | | | | | | | | | Storage stability | |
| | | Composition of black matrix resist (mass part) | | | | | | | | | (Photosensitivity | |
| | | | Compound | | | | | | | | (mJ/cm²) | |
| | | | having an | | | | | | | | | After |
| | | | ethylenically | | | | Organic | Photo- | Reso- | OD | Immediately | 4 weeks |
| | | Carbon black | unsaturated | Photopolymerization | | Thiol | solvent | sensitivity | lution | Value | after | at room |
| | | dispersion | group | intiator | | compound | (cyclohexanone) | (mJ/cm²) | (μm) | (/μm) | preparation | temperature |
| Exam- | 1 | Dispersion 1 | DPHA | EMK | MHABI | TPMB | 150.0 | 40 | 6 | 4.2 | 40 | 60 |
| ple | | 420.0 | 8.4 | 1.0 | 5.0 | 5.0 | | | | | | |
| | 2 | Dispersion 2 | DPHA | EMK | MHABI | TPMB | 150.0 | 100 | 6 | 4.0 | 100 | 120 |
| | | 420.0 | 8.4 | 1.0 | 5.0 | 5.0 | | | | | | |
| | 3 | Dispersion 3 | DPHA | EMK | MHABI | TPMB | 150.0 | 80 | 6 | 4.2 | 80 | 100 |
| | | 420.0 | 8.4 | 1.0 | 5.0 | 5.0 | | | | | | |
| | 4 | Dispersion 4 | DPHA | EMK | Irgacure | TPMB | 150.0 | 80 | 6 | 4.2 | 80 | 100 |
| | | 420.0 | 8.4 | 1.0 | 907 | 5.0 | | | | | | |
| | | | | | 5.0 | | | | | | | |
| | 5 | Dispersion 5 | DPHA | Irgacure | | PGMB | 150.0 | 80 | 6 | 4.2 | 100 | 120 |
| | | 420.0 | 8.4 | 369 | | 5.0 | | | | | | |
| | | | | 6.0 | | | | | | | | |
| | 6 | Dispersion 6 | DPHA | EMK | MHABI | TPMIB | 150.0 | 80 | 6 | 4.0 | 80 | 80 |
| | | 420.0 | 8.4 | 1.0 | 5.0 | 10.0 | | | | | | |
| Com* | 1 | Dispersion 1 | DPHA | EMK | MHABI | TPMP | 150.0 | 20 | 6 | 4.2 | 20 | 300 |
| | | 420.0 | 8.4 | 1.0 | 5.0 | 5.0 | | | | | | |
| | 2 | Dispersion 1 | DPHA | EMK | MHABI | MBT | 150.0 | 300 | 20 | 4.2 | 300 | 500 |
| | | 420.0 | 8.4 | 1.0 | 5.0 | 5.0 | | | | | | or more |

*Com indicates Comparative Example

### INDUSTRIAL APPLICABILITY

By using a branched multifunctional thiol compound having a so-called branched structure at the α-position and/or β-position in combination with a conventional photopolymerization initiator, it is possible to simultaneously achieve maintenance and improvement of high sensitivity and improvement of storage stability, which has not been achieved by use of conventional liner type thiol or conventional aromatic thiols such as mercaptobenzothiazole. The photosensitive composition of the present invention containing such a branched multifunctional thiol compound is suitable for the production of black matrix resist compositions having high precision and high light shielding ratio and is suitable particularly for development type resists that form patterns with high resolution.

1. A photosensitive composition for color filter black matrix resists, comprising (A) a binder resin having a carboxyl group, (B) a compound having an ethylenically unsaturated bond, (C) a photopolymerizing initiator, (D) a thiol compound having two or more mercapto-group-containing groups in which carbon atom(s) at α-position and/or β-position with respect to the mercapto group have a substituent, and (E) an organic solvent.

2. The photosensitive composition for color filter black matrix resists according to claim 1, wherein at least one of the substituents in the thiol compound (D) is an alkyl group.

3. The photosensitive composition for color filter black matrix resists according to claim 2, wherein the alkyl group of the thiol compound (D) is a linear or branched alkyl group having 1 to 10 carbon atoms.

4. The photosensitive composition for color filter black matrix resists according to claim 1, wherein the mercapto-group-containing group of the thiol compound (D) is represented by the following formula (1)
—(CH₂)ₘC(R¹)(R²)(CH₂)ₙSH (1)
(in the formula, R¹ and R² independently represent each a hydrogen atom or an alkyl group, at least one of R¹ and R² is an alkyl group, m is an integer of 0 or 1 to 2, and n is 0 or 1.)

5. The photosensitive composition for color filter black matrix resists according to any one of claims 1 to 4, wherein the thiol compound (D) is an ester of a mercapto group-containing carboxylic acid represented the following formula (2)
HO—CO—(CH₂)ₘC(R¹)(R²)(CH₂)ₙSH (2)
(in the formula, R¹ and R² independently represent each a hydrogen atom or an alkyl group, at least one of R¹ and R² is alkyl group, m is an integer of 0 or 1 to 2, and n is 0 or 1) with a multifunctional alcohol.

6. The photosensitive composition for color filter black matrix resists according to claim 5, wherein the multifunctional alcohol is one or more of compounds selected from a group consisting of alkylene glycol (provided that the alkylene group has 2 to 10 carbon atoms and may be branched), diethylene glycol, glycerol, dipropylene glycol, trimethylolpropane, pentaerythritol and dipentaerythritol.

7. The photosensitive composition for color filter black matrix resists according to claim 5, wherein the multifunctional alcohol is a high molecular polymer having a hydroxyl group.

8. The photosensitive composition for color filter black matrix resists according to claim 1, wherein the binder resin having a carboxyl group (A) further has an ethylenically unsaturated group.

9. The photosensitive composition for color filter black matrix resists according to claim 8, wherein the binder resin having a carboxyl group (A) is an acrylic copolymer.

10. The photosensitive composition for color filter black matrix resists according to claim 1, wherein the photopolymerization initiator (C) contains a hexaaryl biimidazole compound and/or an aminonacetophenone compound.

11. The photosensitive composition for color filter black matrix resists according to claim 10, wherein the hexaaryl biimidazole compound is represented by the following formula (3) 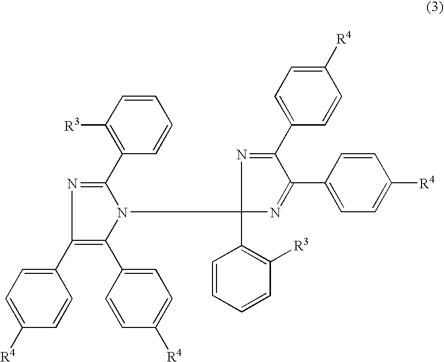
(in the formula, R³ represents a halogen atom, R⁴ represents an alkyl group having 1 to 4 carbon atoms that may have a substituent, or an alkoxy group that may have a substituent).

12. The photosensitive composition for color filter black matrix resists according to claim 1, wherein the photopolymerization initiator (C) contains at least one compound selected from the group consisting of a benzophenone-based compound, a thioxanthone-based compound, and a ketocoumarin-based compound as a sensitizer.

13. The photosensitive composition for color filter black matrix resists according to claim 1, wherein respective components excluding the organic solvent (E) are contained in the following ratio based on the total amount of the components:

| | | |
|---|---|---|
| (A) | a binder resin having a carboxyl group | 30 to 70 mass % |
| (B) | a compound having an ethylenically unsaturated | 5 to 40 mass % |
| | compound | |
| (C) | a photopolymerization initiator | 3 to 30 mass % |
| (D) | a thiol compound having two or more mercapto- | 3 to 30 mass %. |
| | group-containing groups in which carbon atoms | |
| | at α-position and/or β-position with respect to | |
| | the mercapto group have a substituent | |

14. A color filter black matrix resist composition comprising the photosensitive composition for color filter black matrix resists according to claim 1 and a black pigment (F).

15. The color filter black matrix resist according to claim 14, wherein the black pigment (F) contains carbon black.

16. The color filter black matrix resist composition according to claim 14, wherein respective components excluding the organic solvent (E) are contained in the following ratios based on the total amount of the components:

| | | |
|---|---|---|
| (A) | a binder resin having a carboxyl group | 10 to 30 mass % |
| (B) | a compound having an ethylenically unsaturated | 2 to 20 mass % |
| | compound | |
| (C) | a photopolymerization initiator | 2 to 15 mass % |
| (D) | a thiol compound having two or more mercapto- | 2 to 15 mass % |
| | group-containing groups in which carbon atoms | |
| | at α-position and/or β-position with respect to | |
| | the mercapto group have a substituent | |
| (F) | a black pigment | 40 to 70 mass %. |
